(19) United States
(12) Patent Application Publication
(10) Pub. No.: US 2008/0246254 A1
(43) Pub. Date: Oct. 9, 2008

(54) Foldable mirror assembly for hitching trailers

(76) Inventor: Scott Tyerman, Kelowna (CA)

Correspondence Address: Scott Tyerman, 2830 Monford Road, Kelowna, BC, V1V 2G4, CA

(21) Appl. No.: 12/078,959

(22) Filed: Apr. 8, 2008

Related U.S. Application Data
(60) Provisional application No. 60/922,388, filed on Apr. 9, 2007.

(51) Int. Cl. B60D 1/36

(52) U.S. Cl. 280/477

(57) ABSTRACT

A foldable mirror assembly used to assist an operator to align a hitch on a trailer to the hitch of a vehicle while hitching a vehicle to a trailer, consisting of a base for mounting to the rear of a vehicle, support arms that pivot upwards and outwards to the rear of the vehicle, that support a convex mirror that is angled to give the operator a line of sight to the rear of the vehicle. The support and mirror components fold substantially flat to the base which enables the base to remain installed on the rear of the vehicle in the closed position while not in use. Alternatively, The assembly can be removably attached, and therefore folded to the closed position, and then removed and stored after using.

### BACKGROUND OF THE INVENTION

The present invention relates generally to a visual aid device, and more particularly, it relates to a mirror assembly used to assist an operator to align a hitch on a trailer to the hitch of a vehicle.

It is often difficult for an operator to precisely align a trailer hitch with the receiving hitch of a tow vehicle so as to enable the attachment of the trailer to the vehicle. Because there is no direct visual sightline from the operator's seat of the tow vehicle to the rear of the vehicle where the receiving hitch is positioned, there is no means for the operator alone to align the trailer hitch with the receiving hitch without the operator getting out of the vehicle a multiple number of times to determine the position of the receiving hitch of the vehicle relative to the position of the trailer. If a second person is not available to assist the operator, the process of aligning the trailer hitch with the receiving hitch of the vehicle alone usually involves the operator getting out of the vehicle frequently to determine how to maneuver the vehicle and repeated unsuccessful attempts at backing the tow vehicle towards the trailer. Not only is the process of aligning and connecting a tow vehicle to a trailer without assistance generally frustrating and time consuming, it is also potentially dangerous to the operator who is repeatedly exiting the vehicle, sometimes near traffic. Back injuries are also not uncommon when the tow vehicle hitch is not close enough to the trailer hitch and the operator needs to manually move the trailer hitch to the hitch on the vehicle.

Typically, the assistance of a second person is required to effectively and safely align the hitches. Usually, the second person stands behind the tow vehicle and directs the operator by way of hand signals and loud verbal communication to back the vehicle towards the trailer. Such two person method, although commonly used and arguably more effective than the operator attempting to align the hitches alone, still poses potential harm, especially to the second person standing behind the tow vehicle, who risks being crushed or otherwise hit by the vehicle.

In addition to potential damage to the operator and/or the second person, the conventional methods of aligning and connecting hitches described above may also cause damage to the trailer and/or tow vehicle hitches. Most hitches virtually need to be oriented precisely on top of the other in order to properly and securely couple together. Some hitches may be manually lifted to connect the trailer with the tow vehicle if the tow vehicle is not backed close enough to the trailer. Many larger trailers are too heavy to be manually manipulated or nudged into proper alignment for coupling, so an exact alignment is especially crucial in such cases. Quite often, because the hitches need to be so precisely aligned and in close proximity to each other, damage occurs to either (or both) the trailer hitch or the rear of the tow vehicle due to the operator backing up too far.

Various devices have been provided to facilitate the connecting of a tow vehicle to a trailer. For example, U.S. Pat. No. 6,102,423 to Beck et al. describes a detachable visual alignment aid for connecting the ball of the hitch on a towing vehicle to the socket on the tongue of the trailer. U.S. Pat. No. 6,022,116 to Osborn discloses a support device for temporarily supporting a mirrored surface from a tow vehicle, the device being mountable near the tow attachment in order to allow the viewing of the towing coupling while connecting the towing coupling to an object to be towed. U.S. Pat. No. 5,971,555 to Wilcox et al. discloses a hitch viewing mirror assembly comprising a U shaped perimeter frame and a planar mirror pivotally mounted to the frame wherein the frame is mountable to a vehicle by a plurality of suction cups mounted at various locations along the frame. The problem with such prior art hitching devices is that they describe detachable mirror assemblies that require inconvenient re-mounting on the vehicle and/or readjusting every time the device is put to use. The prior art hitching devices are designed to be removed from the tow vehicle when not in use and need to be properly stored, whether in the vehicle, in the garage, or any other suitable storage location, to prevent damage until next use. As such, the prior art hitching devices are not conveniently and immediately readily available for use when required because they need to be located and retrieved from storage and mounted on the vehicle and/or adjusted prior to use.

Other prior art hitching devices disclose the use of stanchion poles as markers placed on the hitches but such are time consuming to set-up and need to be stored, therefore they are not readily available for use. Other more complex devices include electronic sensors or cameras with displays mounted in the tow vehicle to visually or audibly aid the alignment process. These complex devices are costly and require extensive modification to the tow vehicle in their installation. Furthermore, sensitive electronics are potentially vulnerable to malfunction due to dirt, corrosion, and destructive conditions due to foul exterior road elements that could inhibit their effective use.

None of the aforementioned patents disclose a reliable foldable mirror assembly for hitching trailers that is immediately available for use without mounting or adjustments. In this respect, the present invention substantially departs from the conventional concepts and designs of the prior art. A need for an improved hitching device therefore exists.

### BRIEF SUMMARY OF THE INVENTION

It is an object of the invention to provide a foldable mirror assembly for hitching trailers that may remain attached to the towing vehicle.

It is a further object of the invention to provide a foldable mirror assembly for hitching trailers suitable for all types of vehicles having a towing hitch.

In accordance with the invention, a foldable mirror assembly for hitching trailers is provided, the mirror assembly comprising a base, a first and a second support arm, each of the first and second support arms pivotably coupled with the base at a first end, and a mirror mounted on a support wherein the support is pivotably coupled with each of the first and second support arm at a second end of the first and second support arm. The first and second support arms and the support are collapsible from a first open position to a second closed position wherein in the first open position, the first and second support arms and the support pivotably move in angulated positions relative to each other and in the second closed position, the first and second support arms and the support are each received in recesses defined by the base such that the first and second support arms and the support may be secured to the base in a substantially flat configuration.

### BRIEF DESCRIPTION OF THE DRAWINGS

These and other objects, benefits, or advantages of the invention are described in more detail and will be apparent after reviewing the drawings and description thereof wherein:

FIG. 1 is a perspective view of a preferred embodiment of the present invention mounted on the rear of a vehicle;

FIG. 2 is a side perspective view of the invention as seen in FIG. 1 in use to align with a trailer;

FIG. 3 is a rear view of the invention as seen in FIG. 1;

FIG. 4 is a perspective view of the invention as seen in FIG. 1 mounted on the rear of another type of vehicle;

FIG. 5 is a perspective view of the invention as seen in FIG. 1 in the closed position;

FIG. 6 is a cross sectional side view of the invention in the open position as shown in FIG. 1;

FIG. 7 is an exploded perspective view of the preferred pivotal means of the invention seen in FIG. 1; and

FIG. 8 is a perspective view of an alternative embodiment of the invention.

### DETAILED DESCRIPTION OF THE INVENTION

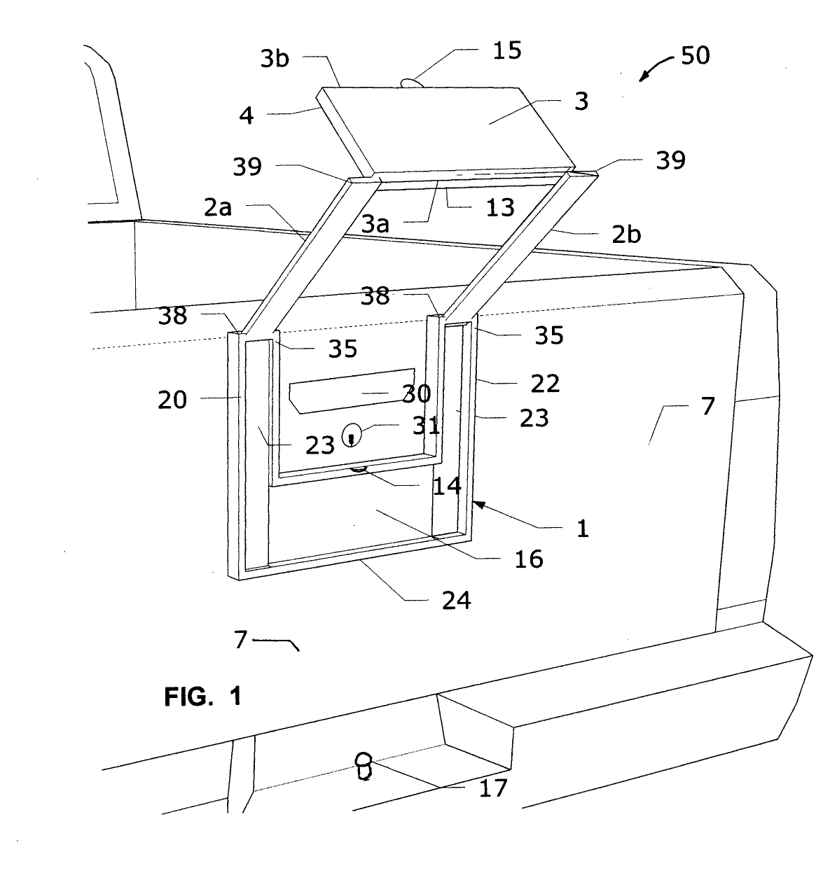

With reference to FIGS. 1 to 7, a foldable mirror assembly 50 for hitching trailers comprises a base 1, a first and a second support arm 2a, 2b each pivotably coupled with base 1 at a first end, and a mirror 4 mountable on a support 3 wherein support 3 is pivotably coupled with a second end of each first and second support arms 2a, 2b.

Base 1 may be made of any durable material suited for outdoor use such as but not limited to aluminum, stainless steel, fiberglass, or plastic. Preferably, base 1 is made of injection molded plastic. Base 1 further comprises at least one attachment means configured to attach base 1 to the rear of a vehicle 7 in a manner best seen in FIGS. 1, 3, and 4. Base 1 may be attached to the rear of virtually any vehicle, such as but not limited to pick up trucks (with or without canopies, box covers, or dry boxes), cars with hatches or trunks, sport utility vehicles, and vans. Suitable attachment means for attaching base 1 of foldable mirror assembly 50 to the rear of vehicle 7 include but are not limited to hooks, screws, magnets, two-sided adhesive, hook and loop fasteners, and suction cups. In the preferred embodiment, base 1 is secured to the rear of vehicle 7 such that foldable mirror assembly 50 may remain attached to vehicle 7 without the need to be removed when not in use, whether vehicle 7 is in motion or stationary. In such preferred embodiment, foldable mirror assembly 50 may be permanently attached or remain detachably attached to vehicle 7 without affecting the functioning or interfering with drivability of vehicle 7, as described in greater detail below. In an embodiment of the invention, foldable mirror assembly 50 may be incorporated into the manufacture of vehicle 7 as a fixed installation. Alternatively, foldable mirror assembly 50 may be an after market installation that may be fixedly mountable with the rear of vehicle 7. In the further alternative, foldable mirror assembly 50 may be an after market installation detachably mounted with the rear of vehicle 7. Preferably, foldable mirror assembly 50 may be securely attached with vehicle 7 by suitable attachment means such as suction cups, two-sided adhesive, or magnets or the like such that foldable mirror assembly 50 may remain secured to vehicle 7 when not in use and foldable mirror assembly 50 may be detached from vehicle 7 only if desired without permanently damaging, altering or otherwise affecting the exterior of vehicle 7 when detached.

In a preferred embodiment of the invention, base 1 is generally U-shaped although base 1 may be of any shape or configuration as long as it may receive support 3 and first and second support arms 2a, 2b in a substantially flat configuration, as described in greater detail below. As best seen in FIGS. 1, 3, and 4, base 1 may be attached with the rear of vehicle 7 so as not to interfere with the usual location of most tailgate latches 30 and trunk keyholes 31 on vehicle 7. In the preferred embodiment, base 1 is attached with the rear of vehicle 7 such that tailgate latch 30 and trunk keyhole 31 are disposed in between a first and second side 20, 22 of base 1 within the void defined by the U-shape of base 1, as best seen in FIG. 1.

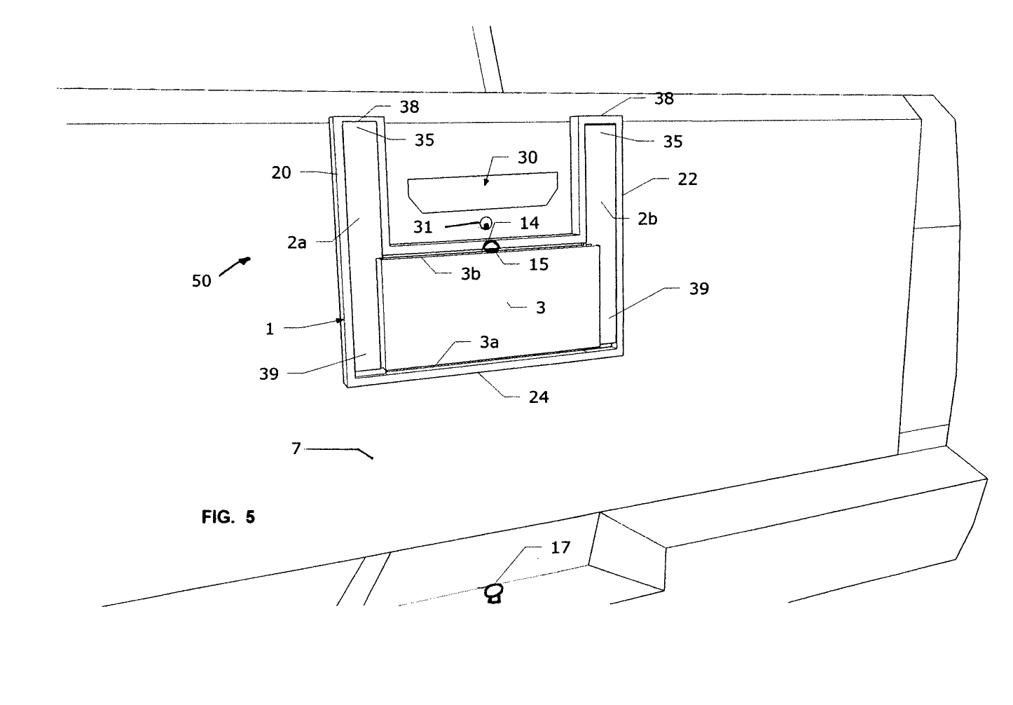

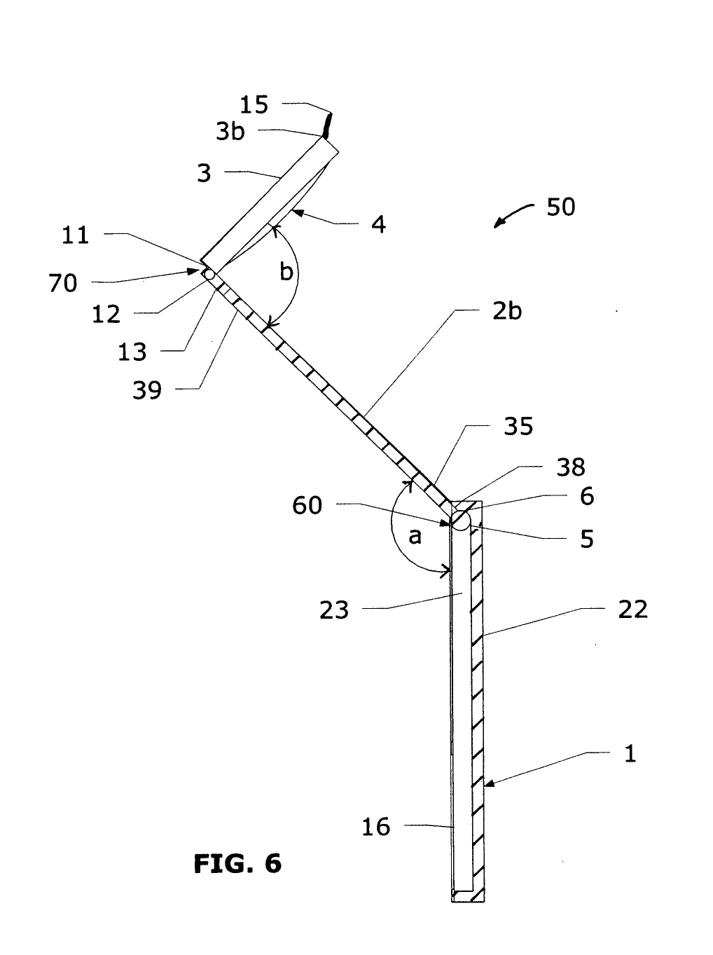

Base 1 preferably comprises a plurality of recesses configured to receive first and second support arms 2a, 2b and support 3 when foldable mirror assembly 50 collapses from the first open position, as best seen in FIGS. 1 and 6, to the second closed position, as best seen in FIG. 5. For greater clarity, each of first and second sides 20, 22 of base 1 may be recessed to form support arm depressions 23 conforming to the shape and configuration of support arms 2a, 2b such that when support arms 2a, 2b collapse from the first open position to the second closed position, support arms 2a, 2b may be received and retained in support arm depressions 23 in a substantially flat configuration. Similarly, a third side 24 of base 1 may be recessed to form support depression 16 conforming to the shape and configuration of support 3 such that when support 3 collapses from the first open position to the second closed position, support 3 may be received and retained in support depression 16 in a substantially flat configuration. Support arm depressions 23 and support depression 16 are recessed so as to protect first and second support arms 2a, 2b and mirror 4 mounted on support 3 and to effectively reduce the overall thickness of foldable mirror assembly 50 when stowed on vehicle 7 in the second closed position.

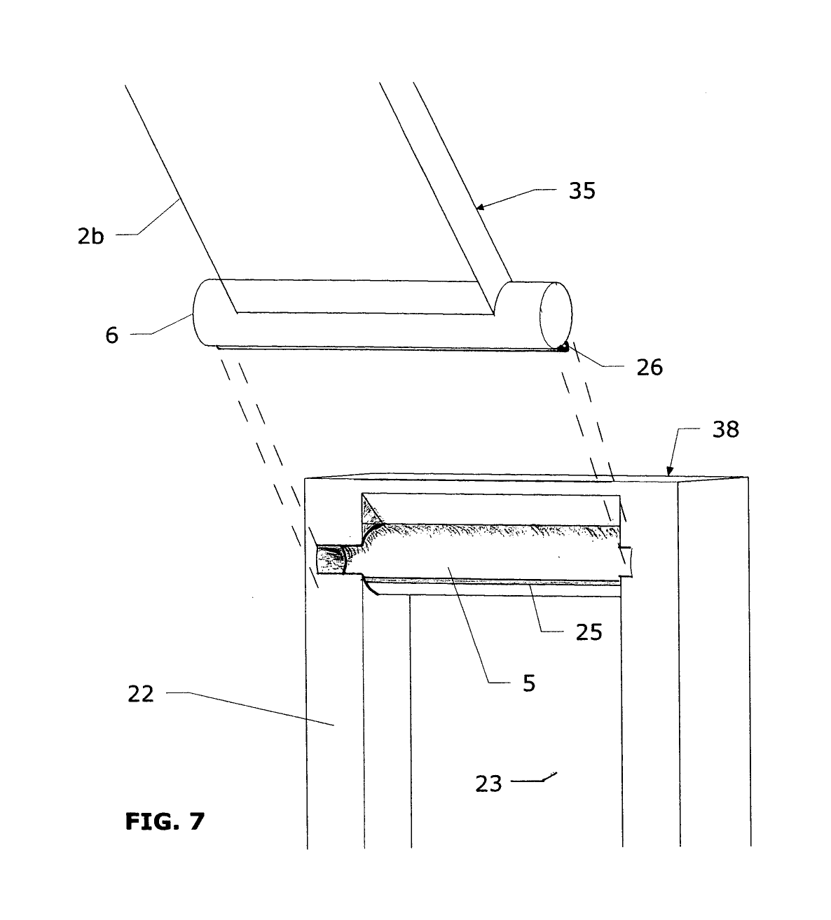

As best seen in FIG. 6, first and second support arms 2a, 2b are preferably pivotably coupled with first and second sides 20, 22, respectively, by way of a first pivot means 60 such that first and second support arms 2a, 2b may pivot relative to first and second sides 20, 22, respectively. A first end 35 of each of first and second support arms 2a, 2b may be pivotably coupled with a first end 38 of first and second sides 20, 22, respectively, by any pivot means that may enable the retention of first and second support arms 2a, 2b in a first desired position unless adjusted otherwise. In a preferred embodiment of the invention, each first end 38 of first and second sides 20, 22 comprises a socket 5 adapted to receive a knuckle 6 formed at first end 35 of each of first and second support arms 2a, 2b such that first and second support arms 2a, 2b may pivot within socket 5 relative to first and second sides 20, 22 when knuckle 6 is received in socket 5. By way of example, FIG. 7 depicts first pivot means 60 as previously described with respect to first support arm 2a in relation to first side 20 but applies equally to second support arm 2b in relation to second side 22. Preferably, when knuckle 6 is received in socket 5, knuckle 6 frictionally engages socket 5 such that first and second support arms 2a, 2b may be pivoted only when sufficient force is applied, for example, when manually adjusted by a user to position foldable mirror assembly 50 for hitching a trailer. Absent the application of sufficient force to first and second support arms 2a, 2b, the friction fit and frictional engagement of knuckle 6 in socket 5 otherwise substantially retains first and second support arms 2a, 2b in the first desired position determined by angle a for optimal viewing, as seen in FIG. 6. First pivot means 60 may also include a detent mechanism, such as but not limited to a spring or friction based detent member, to provide at least one detent stop point to assist in substantially retaining first and second support arms 2a, 2b in angle a in the first desired position unless otherwise adjusted. Otherwise, first and second support arms 2a, 2b may be generally retained in a substantially static position at angle a by the friction fit of knuckle 6 received in socket 5.

First pivot means 60 enables first and second support arms 2a, 2b to pivot between the first open position and the second closed position relative to base 1. When in the second closed position, as best seen in FIG. 5, both first and second support arms 2a, 2b may be received in support arm depressions 23 and when in the first open position, as best seen in FIGS. 1 and 6, first and second support arms 2a, 2b may pivot upwards and away from base 1. For greater clarity, first pivot means 60 enables first and second support arms 2a, 2b to pivot upwards and away from base 1 from the second closed position where first and second support arms 2a, 2b are received in support arm depressions 23, to the first desired position determined by angle a. First pivot means 60 enables first and second support arms 2a, 2b to be pivoted and substantially retained in the first desired position at angle a when in the first open position to assist in positioning mirror 4 on support 3 in an optimal viewing position, as described in greater detail below.

When foldable mirror assembly 50 is secured to and used in association with a vehicle having a substantially vertical rear surface, such as a pick-up truck and certain sport utility vehicles, for optimal viewing, first and second support arms 2a, 2b may be pivoted upwards and away from base 1 and substantially retained frictionally in the first desired position by first pivot means 60 at angle a which may range between 130 degrees and 140 degrees relative to base 1. In the preferred embodiment, when foldable mirror assembly 50 is secured to and used in association with a vehicle having a substantially vertical rear surface, angle a for optimal viewing is generally 135 degrees relative to base 1 mounted on a substantially vertical surface. To assist in substantially retaining first and second support arms 2a, 2b in the first desired position at angle a, preferably, each socket 5 comprises a groove 25 and each knuckle 6 comprises a ridge 26 corresponding to groove 25 such that when first and second support arms 2a, 2b are pivoted to angle a, groove 25 and ridge 26 mate to secure first and second support arms 2a, 2b at angle a when in the first open position for backing vehicle 7 towards a trailer 8 for connection. Angle a is optimum for vehicles having a substantially vertical rear surface as angle a assists in positioning mirror 4 at the optimal angle for a user to view the hitch area 17 of vehicle 7 and trailer 8 when vehicle 7 backs towards trailer 8.

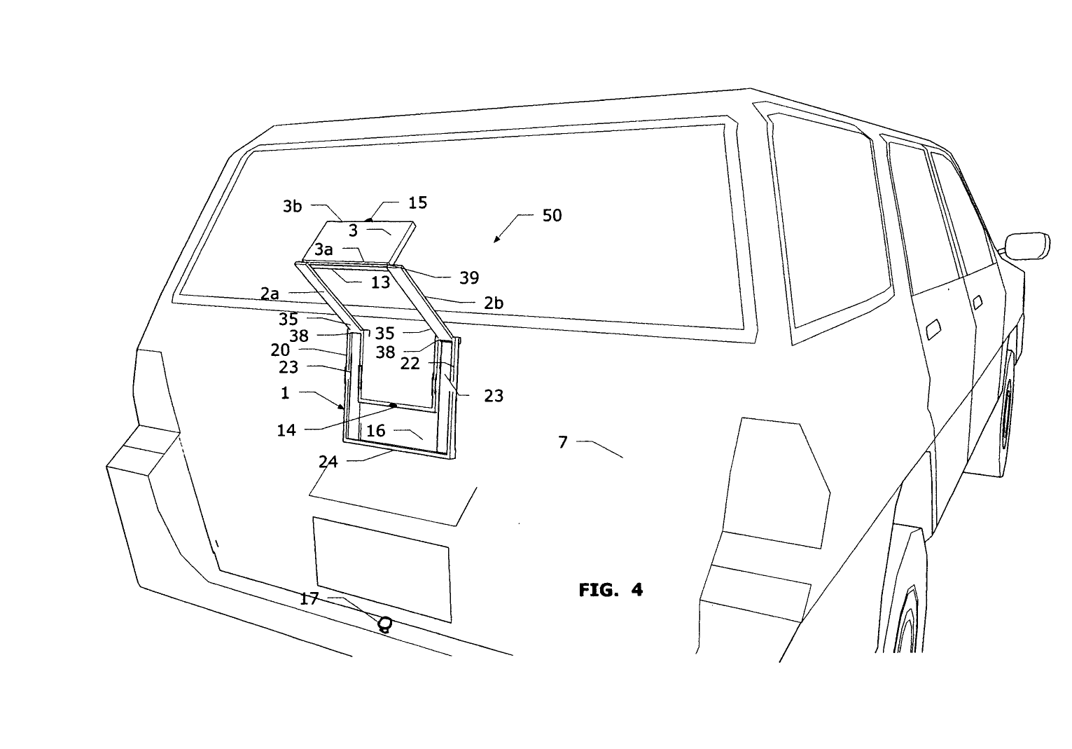

As seen in FIG. 4, when foldable mirror assembly 50 is secured to and used in association with a vehicle having a rear surface that is not substantially vertical, such as a conventional car or a hatch back vehicle which has a generally sloped rear surface, to compensate for base 1 being secured to a sloped surface instead of a substantially vertical surface and to achieve optimal viewing, first and second support arms 2a, 2b are preferably substantially retained frictionally by first pivot means 60 at a smaller angle a compared to angle a when foldable mirror assembly 50 is secured to and used in association with a vehicle having a rear surface that is substantially vertical. Preferably, when foldable mirror assembly 50 is secured to and used in association with a vehicle having a rear surface that is not substantially vertical, angle a for optimal viewing is generally in the range between 30 degrees and 130 degrees relative to base 1. The frictional engagement of knuckle 6 in socket 5 enables user to adjust and control the position of first and second support arms 2a, 2b to ensure first and second support arms 2a, 2b are retained in the first desired position at angle a while vehicle 7 is backed towards a trailer 8 for connection.

In the second closed position wherein first and second support arms 2a, 2b and support 3 are received in base 1 in a substantially flat configuration, foldable mirror assembly 50 may be stored or remain attached with vehicle 7 while it is not in use. Advantageously, foldable mirror assembly 50 may be readily available for use at any time with no need for storage, retrieval, and/or remounting.

As best seen in FIGS. 1 and 6, support 3 is preferably generally rectangular and may be pivotably coupled with both first and second support arms 2a, 2b by way of a second pivot means 70 such that support 3 may pivot relative to both first and second support arms 2a, 2b. Preferably, second pivot means 70 is positioned along the bottom edge 3a of support 3, thus allowing support 3 to pivot parallel to third side 24 of base 1. In a preferred embodiment of the invention, second pivot means 70 is substantially the same as and operates in a substantially similar manner to first pivot means 60 described above. Support 3 may be pivotably coupled with each of first and second support arms 2a, 2b at a second end 39 of first and second support arms 2a, 2b such that support 3 may be retained in a second desired position at angle b relative to the first desired position of first and second support arms 2a, 2b, unless otherwise adjusted. In a preferred embodiment of the invention, a knuckle 12 is formed at each second end 39 of first and second support arms 2a, 2b. Each knuckle 12 is adapted to be received in a socket 11 formed along bottom edge 3a of support 3 such that support 3 may pivot relative to first and second support arms 2a, 2b when each knuckle 12 is received in each socket 11. In a preferred embodiment of the invention, when knuckle 12 is received in socket 11, knuckle 12 frictionally engages socket 11 such that support 3 may be pivoted only when sufficient force is applied, for example, when manually adjusted by a user to position mirror 4. Absent the application of sufficient force to support 3, the friction fit and frictional engagement of knuckle 12 in socket 11 causes support 3 to be retained in the second desired position determined by angle b, as seen in FIG. 6.

In an embodiment of the invention, first and second support arms 2a, 2b may further comprise a cross member 13 disposed between first support arm 2a and second support arm 2b. Cross member 13 may be attached with each second end 39 of first and second support arms 2a, 2b so as to provide greater rigidity and stability to first and second support arms 2a, 2b when pivoting support 3 relative to first and second support arms 2a, 2b. In such embodiment, knuckle 12 may be formed anywhere along the top edge of cross member 13 as long as each knuckle 12 corresponds to the position of socket 11 formed along bottom edge 3a of support 3 so as to enable pivotal, frictional engagement of each knuckle 12 with its corresponding socket 11. Cross member 13 may be an integrated part of second end 39 of first and second support arms 2a, 2b, thereby incorporating first and second support arms 2a, 2b and cross member 13 into one component. Preferably, for greater rigidity, second pivot means 70 is a piano style hinge connecting the top edge of cross member 13 with bottom edge 3a of support 3. Cross member 13 may be constructed of injection molded plastic but any lightweight, non-corroding, durable material such as aluminum, stainless steel, fiberglass, plastic, or similar materials, fashioned in a method that creates rigidity and compatibility with corresponding parts.

Second pivot means 70 frictionally and pivotably attaches support 3 with a second end 39 of each of first and second support arms 2a, 2b such that support 3 may pivot between the first open position and the second closed position. When in the second closed position, as best seen in FIG. 5, support 3 may be received in support depression 16 and when in the first open position, as best seen in FIGS. 1 and 6, support 3 may pivot upwards and away from both base 1 and first and second support arms 2a 2b. For greater clarity, second pivot means 70 enables support 3 to pivot upwards and away from first and second support arms 2a, 2b and base 1 when in the second closed position where support 3 is received in depression 16 to the second desired position determined by angle b for optimal viewing when in the first open position. Second pivot means 70 enables support 3 to be pivoted and substantially retained in the second desired position at angle b when in the first open position to assist in positioning mirror 4 in an optimal viewing position.

For optimal viewing, support 3 may be pivoted upwards and away from first and second support arms 2a 2b and be substantially retained frictionally by second pivot means 70 at angle b which may range between 80 degrees to 100 degrees relative to first and second support arms 2a 2b substantially retained in the first desired position by first pivot means 60. In the preferred embodiment, angle b for optimal viewing in the first open position is generally 90 degrees relative first and second support arms 2a 2b substantially retained in the first desired position, as best seen in FIG. 6. Similar to first pivot means 60, to assist in substantially retaining support 3 in the second desired position at angle b, preferably, each socket 11 comprises a groove 25 and each knuckle 12 comprises a ridge 26 corresponding to groove 25 such that when support 3 is pivoted to angle b, groove 25 and the ridge 26 mate with each other to substantially secure support 3 and mirror 4 in angle b when in the first open position for backing vehicle 7 towards trailer 8.

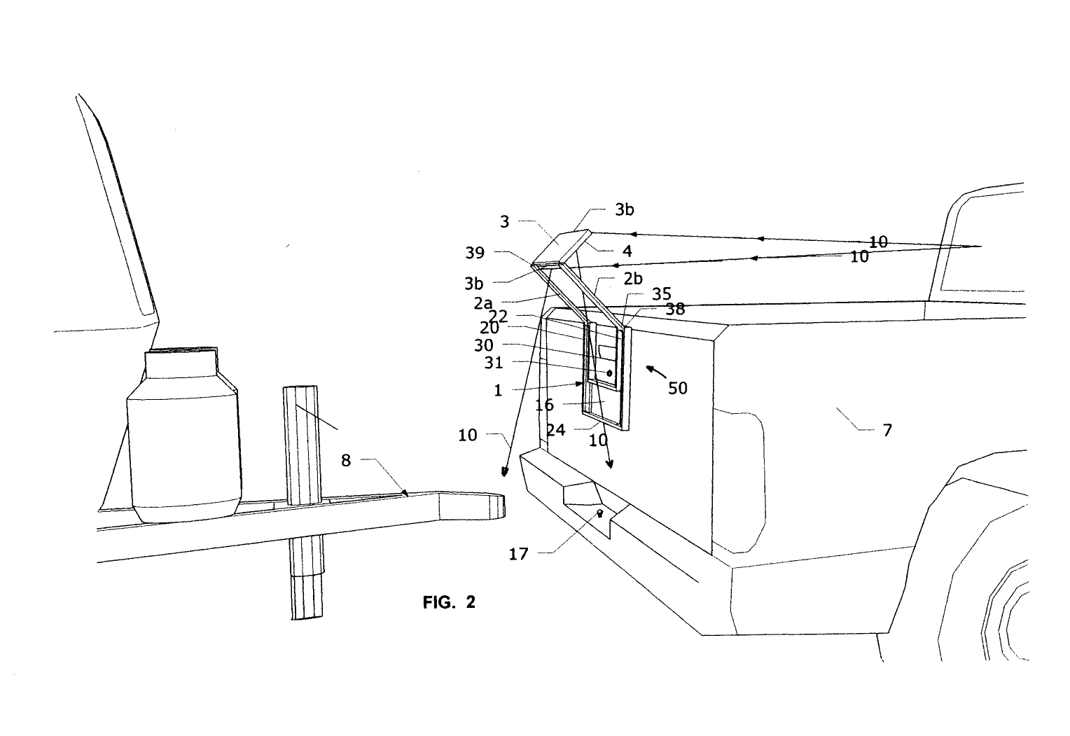

When first and second support arms 2a 2b are pivoted to angle a in the first desired position, support 3 may also be pivoted to angle b so as to position mirror 4 in the optimal viewing position to provide the operator in the driver position of vehicle 7 with a substantially clear line of sight 10 to mirror 4 via the existing rear view mirror of vehicle 7 or viewing mirror 4 through the rear window of vehicle 7 over obstacles such as a tool box, fuel tank, box cover, rear seating, passengers or cargo in the rear of vehicle 7 as best seen in FIG. 2. The optimal viewing position of mirror 4 provides the operator with an unobstructed view of hitch area 17 during the hitching process. The preferred angle b of support 3 relative to first and second support arms 2a 2b in the first desired position in combination with the preferred angle a of first and second support arms 2a, 2b relative to base 1 as previously described, results in a virtually right angle line of sight 10 for an operator from the driving position in vehicle 7 by reflecting the view of hitch area 17 through mirror 4 to the operator via the existing rear view mirror of vehicle 7 or by viewing mirror 4 through the rear window of vehicle 7, as best seen in FIG. 2. Any necessary adjustments to foldable mirror assembly 50 for optimal viewing may be made by adjusting angle a by adjusting first pivot means 60 as it would be more effective to correct an unfavorable angle caused by foldable mirror assembly 50 not being attached in a substantially vertical position at first pivot means 60. Preferably, mirror 4 is slightly convex so as to enlarge the view of hitch area 17 to further assist the operator, as seen in FIG. 6.

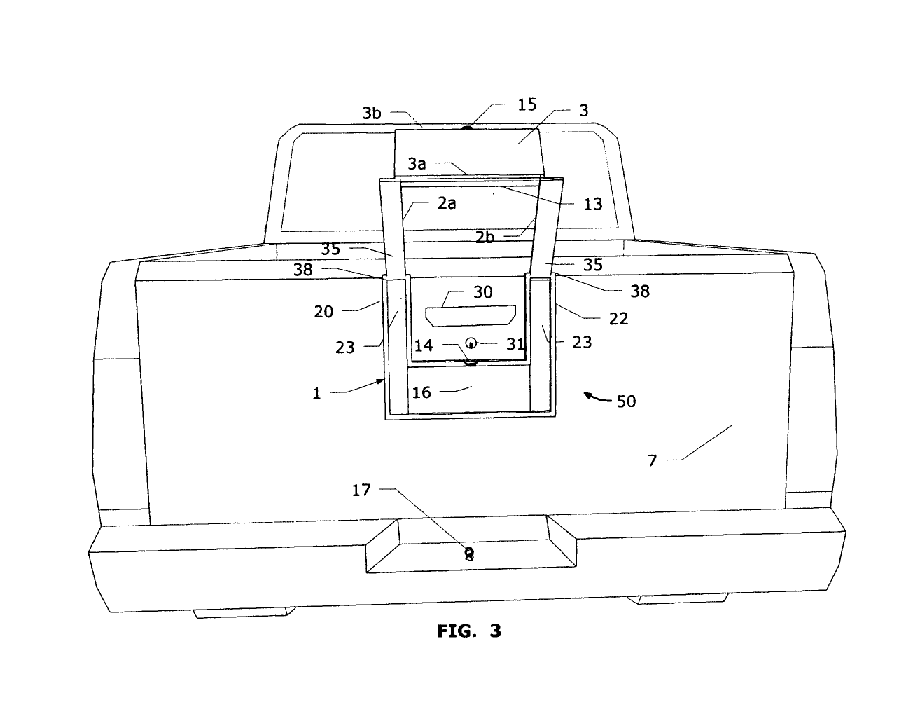

As seen in FIG. 3, support 3 is disposed between support arms 2a, 2b so as to enable support 3 to be received within depression 16 and support arms 2a, 2b to be received within depressions 23 in a substantially flat configuration when in the second closed position. Preferably, support 3 and mirror 4 are of suitable size to enable the operator to have a clear view of hitch area 17 from the driver position in vehicle 7. The size of support 3 and mirror 4 are only limited by the dimensions of base 1 which is preferably between 8 and 24 inches in length along third side 24 and between 8 and 16 inches in height along first and second sides 20, 22 such that base 1 may be mounted on the rear of vehicle 7 without affecting the viewing function of foldable mirror assembly 50 or impeding or interfering with the function of vehicle 7, such as operation of the trunk or visibility through the rear window from the driver's position. As such, the dimensions of support 3 are preferably between 6 and 24 inches in length along bottom edge 3a and top edge 3b and between 4 and 8 inches in height along the sides of support 3 such that support 3 may be received in depression 16 when in the second closed position for compact stowage and to protect mirror 4 when foldable mirror assembly 50 is not in use.

In an embodiment of the invention, support 3 may further comprise a fastening means such as, without intending to be limiting, a catch 15 on top edge 3b. A corresponding latch 14 may be mounted on base 1 such that latch 14 and catch 15 may be fastened together when support 3 is in the second closed position so as to securely retain support 3 and first and second support arms 2a, 2b in a substantially flat configuration against and within base 1. The fastening means enables support 3 and first and second support arms 2a, 2b to be secured substantially flat against base 1 for convenient stowage when not in use and in the second closed position, as illustrated on FIG. 5. Advantageously, the ability to conveniently stow foldable mirror assembly 50 on vehicle 7 in the second closed position when not in use has not been previously disclosed, taught or suggested in the prior art. The folding and retaining of foldable mirror assembly 50 on vehicle 7 when not in use makes it possible for the operator to keep foldable mirror assembly 50 attached to vehicle 7 at all times, thus negating the need for removal or storage. For greater convenience, in an embodiment of the invention, foldable mirror assembly 50 may be mounted to the rear of vehicle 7 such that catch 15 may be coupled with a cable, electric solenoid or similarly operated linkage to enable the operator to release catch 15 from latch 14 by triggering a lever or switch from the drivers position in the vehicle 7. First and second pivot means 60, 70 may further comprise springs that may be compressed in the second closed position such that upon releasing latch 14, first and second support arms 2a, 2b and support 3 would automatically displace from the second closed position to the first open position. Advantageously, the operator would not need to exit vehicle 7 to open foldable mirror assembly 50 for use during the hitching process.

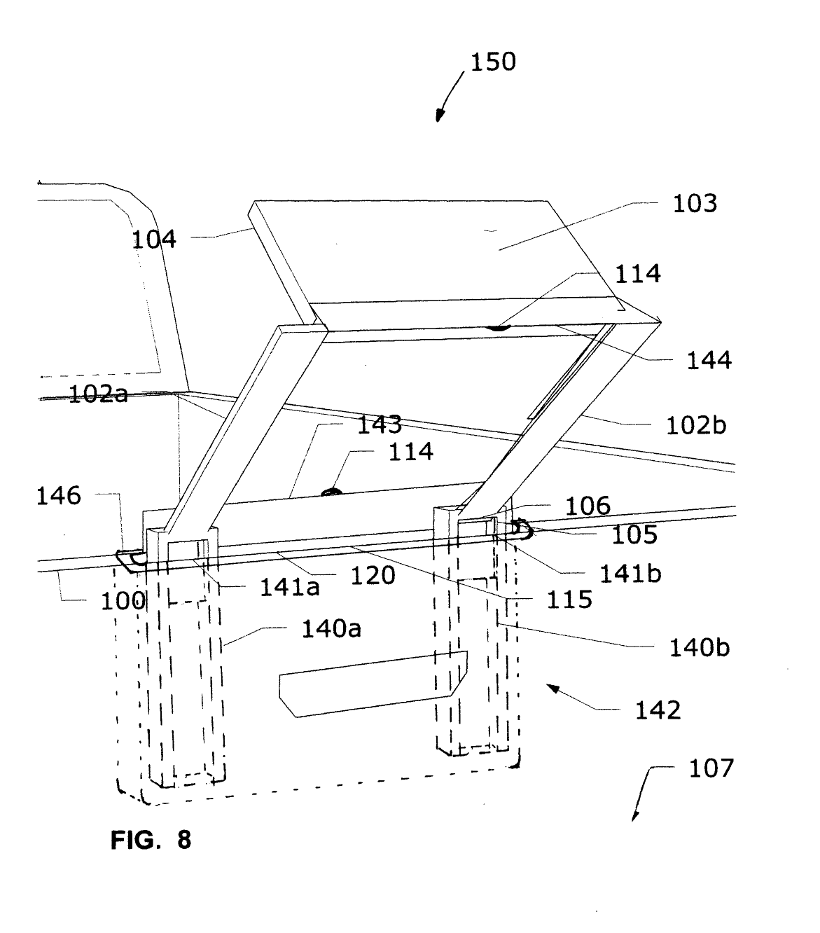

In a second embodiment of the invention, a foldable mirror assembly 150 for hitching trailers may be permanently installed and stored within the rear of a vehicle 107 when not in use, as shown in FIG. 8. Foldable mirror assembly 150 may be preferred where the present invention may be incorporated into the manufacture of vehicle 107. Foldable mirror assembly 150 comprises a first and a second guide rail 140a, 140b disposed within the rear of vehicle 107, a first and a second support arm 102a, 102b slideably mounted on first and second guide rail 140a, 140b, respectively, at a first end, and a mirror 104 mounted on a support 103 wherein support 103 is pivotably coupled with a second end of each of first and second support arms 102a, 102b. First and second support arms 102a, 102b, support 103, and mirror 104 are similar to first and second support arms 2a, 2b, support 3, and mirror 4, respectively, in all respects as described above.

First and second guide rails 140a, 140b may be mounted within the rear of vehicle 107 in a position corresponding to the position of first and second sides 20, 22 of base 1 in the first embodiment such that first and second guide rails 140a, 140b will not interfere with the drivability or affect the functioning of vehicle 107. Preferably, first and second guide rails 140a, 140b are mounted substantially vertically within the rear of vehicle 107 such that each first end of first and second guide rails 140a, 140b are substantially flush with the top edge 100 of vehicle 107. In an embodiment of the invention, first and second guide rails 140a, 140b are each comprised of a channel track and configured to receive a first and a second carrier 141a, 141b, respectively such that first and second carrier 141a, 141b may slide along first and second guide rails 140a, 140b, respectively. First and second support arms 102a, 102b are pivotally coupled with first and second carriers 141a, 141b, respectively such that first and second support arms 102a, 102b may freely slide along first and second guide rails 140a, 140b and extend out from top edge 100 of vehicle 107 and retract completely within the rear of vehicle 107. For greater clarity, first and second support arms 102a, 102b mounted on first and second carriers 141a, 141b, respectively, slide along first and second guide rails 140a, 140b so as to enable foldable mirror assembly 150 to extend from the second retracted position within the rear of vehicle 107 to a first extended position outside of the rear of vehicle 107 for optimal viewing.

Foldable mirror assembly 150 may be retracted and stored within a housing 142 defined by the cavity within the rear of vehicle 107 where first and second guide rails 140a, 140b are mounted to enable first and second support arms 102a, 102b to slide vertically on first and second carriers 141a, 141b between the first extended position and the second retracted position. An aperture 120 defined by top edge 100 enables first and second support arms 102a, 102b and support 103 to extend out of housing 142 to the first extended position for optimal viewing. When not in use, first and second support arms 102a, 102b and support 103 may retract into housing 142. In an embodiment of the invention, a cover 143 pivotably attached to top edge 100 may be pivoted to the closed position to cover aperture 120 when foldable mirror assembly 150 is in the second retracted position and disposed within housing 142 when not in use. When required, cover 143 may be pivoted to the open position to enable foldable mirror assembly 150 to be released from housing 142 and extend through aperture 120 into the first extended position. Alternatively, a cover 144 attached perpendicular to the second end of first and second support arm 102a, 102b, may protect foldable mirror assembly 150 when in the second retracted position.

Advantageously, foldable mirror assembly 150 may virtually be completely contained within housing 142 when not in use. Foldable mirror assembly 150 may be retrofitted to virtually any existing vehicle such as, but not limited to, a truck or sports utility vehicle tailgate, car trunk, hatchback, or rear of a van, if a hidden installation was desired. A suitable sized slot may be cut into the rear surface of an existing vehicle so as to insert and house foldable mirror assembly 150. A flange 146 flush to the top of housing 142 facing outward would cover the exposed cut and provide means of flush attachment to top edge 100 on the rear of the vehicle 107. A detent stop on the top end of first and second guide rails 140a, 140b that correspond to a matching detent stop on first and second carriers 141a, 141b assists in retaining first and second carriers 141a, 141b securely in the first extended position similar to the detent stop described above in relation to first pivot means 60. A socket 105 may be formed at each first end of carriage blocks 141a, 141b to receive and frictionally engage a knuckle 106 formed at each first end of support arms 102a, 102b such that first and second support arms 102a, 102b may frictionally pivot relative to the first ends of first and second carriers 141a, 141b, similar to the first pivot means described above. Support arms 102a, 102b may be pivoted to and secured at any desired angle when in the open position to position mirror 104 on support 103 in an optimal viewing position. The preferred optimal viewing position would be an angle of 45 degrees from the mostly vertical position towards the rear. Support 103 operates similarly to support 3 as previously described above to provide the operator with an unobstructed, right angle, line of sight of the rear of the vehicle. Similar to the mechanism described above, foldable mirror assembly 150 may further comprise a latch 114 on cover 143 or cover 144 and a corresponding catch 115 on top edge 100 or flange 146 to secure cover 143 or 144. Latch 114 may be coupled with a cable, electric solenoid or similarly operated linkage to enable the operator to release latch 114 from catch 115 by triggering a lever or switch from the driver's position in vehicle 107. As well, the pivot means between first and second carrier blocks 141a, 141b and first and second support arms 102a, 102b and the pivot means between first and second support arms 102a, 102b and support 103 may further comprise springs compressed when foldable mirror assembly 150 is in the second retracted position such that upon releasing latch 114, first and second support arms 102a, 102b and support 103 would automatically displace from the second retracted position to the first extended position. Advantageously, the operator would not need to exit vehicle 107 to open the assembly 150.

The present invention may also be used as a device to assist an operator when backing up vehicle 7 for any other purpose or tasks other than trailering, such as, without intending to be limiting, parking vehicle 7 in a small space or backing vehicle 7 into a loading dock. Foldable mirror assembly for hitching trailers 50 may be used by an operator that could benefit from having optimal rear vision immediately behind vehicle 7 from the drivers seat for any vehicular operation.

The foregoing description is made for purpose of illustration only and is not intended to limit the scope of the invention. From the foregoing, it should be clear that the present invention may be embodied in other forms other than those disclosed above without departing from the spirit or essential characteristics of the invention. The above described embodiments are therefore to be considered in all respects illustrative and not restrictive.

The embodiments of the invention in which an exclusive property or privilege is claimed are defined as follows:

1. A visual aid device used by a vehicle operator to align a hitch on a vehicle to the hitch on a vehicle, comprising of a base component, a convex mirror component, and a third support component that pivotably connects the aforesaid components together; allowing convex mirror component along with the support component to rotate to an open position at predetermined angles relative to each other, effectively allowing a vehicle operator to obtain a direct line of sight to a hitch, otherwise, the said components are collapsible to be substantially flat to the base component when not in use.

2. The visual aid device of claim 1, wherein the pivotable connection between the aforesaid base and the support is at or near the top edge of the base and allows frictional movement that would retain the support at an angle rearward and upward relative to the vehicle, which combined with the pivotable connection of the opposite edge of the support to the bottom edge of the mirror which allows a right or near right angle rotation of the mirror upwards relative to the support, which effectively positions the mirror higher relative to the base which allows the operator a clear line of sight to the vehicle rear.

3. The visual aid device of claim 2, wherein the pivotable connections between the support and the mirror is limited to a right or near right angle in the fully extended or open position.

4. The visual aid device of claim 2, wherein the pivotable connection between the base and the support allows frictional movement, towards the open position, upwards and outwards relative to the base when the base is attached vertically to the rear of a vehicle.

5. The visual aid device of claim 3, wherein the method of retaining the said components in the extended position is provided by tension springs.

6. The visual aid device of claim 1, wherein the base is attached to the rear of a vehicle, and includes a clasp that is mechanically or electronically opened by the operator to allow the components to extend to the open position.

7. The visual aid device of claim 1, wherein the method of removably mounting the base to the vehicle is with magnets.

8. The visual aid device of claim 1, wherein the method of attaching the base to the vehicle is with adhesive tape.

9. The visual aid device of claim 1, wherein the method of attaching the base to the vehicle is with adhesive hook and loop tape.

10. The visual aid device of claim 1, wherein the method of removably mounting the base to the vehicle is with hooks formed to the shape of a tailgate in the case of attachment to a pick up truck.

11. The visual aid device of claim 1, wherein the base component is a mostly rectangular housing with vertical guide rails on its opposite ends in which carrier glides are fitted into and allowed to slide vertically to the extents of the guide rails:
Wherein the top end of the said carrier glides are pivotably connected to the support allowing the support component to rotate rearward to an angle that positions the aforesaid mirror component directly above the vehicles hitch.
Wherein the housing that contains the mirror assembly is recessed into the rear of the vehicle, so as the top of the housing is mostly flush to the surface of the vehicle.
